(19) United States
(12) Patent Application Publication
(10) Pub. No.: US 2017/0020170 A1
(43) Pub. Date: Jan. 26, 2017

(54) SPRAY RETORT SYSTEM

(71) Applicant: John Bean Technologies Corporation, Chicago, IL (US)

(72) Inventors: Marc Vandenberghe, Gentbrugge (BE); Jo Suys, Erpe-Mere (BE)

(73) Assignee: John Bean Technologies Corporation, Chicago, IL (US)

(21) Appl. No.: 14/809,114

(22) Filed: Jul. 24, 2015

(51) Int. Cl. A23L 3/02; B65D 5/56; B65D 5/40; B05B 13/02; B65D 5/06

(52) U.S. Cl. CPC A23L 3/02; B05B 13/0278; B65D 5/064; B65D 5/40; B65D 5/563; A23V 2002/00

(57) ABSTRACT

A spray retort system includes a vessel having an interior and a load defined by at least one paperboard container. The at least one paperboard container comprises a body having a top end, a bottom end, and an exposed edge, and the load is positionable within the interior of the vessel. The system further includes at least one nozzle positioned within a top interior portion of the vessel to spray processing fluid onto a top of the load and a first supplemental nozzle arranged on the top interior portion of the vessel to spray processing fluid downwardly along the exposed edge of the at least one paperboard container.

### BACKGROUND

Overpressure retorts are used for the in-container preservation of foodstuffs, either for pasteurization or sterilization processes. In general, these machines use a combination of pressure and temperature to sterilize packaged food according to a predefined schedule. Their popularity has increased in the past few years because of the development of processes that allow for the use of processing fluids other than only saturated steam. Using other processing fluids enables the application of an additional partial overpressure on top of the basic steam vapor pressure associated with the process temperature. Such additional overpressure is useful in coping with new types of containers that are being introduced on the market.

One new type of container is a paperboard container generally composed of a coated piece of paperboard folded into a rectilinear shape that is configured to contain fluids such as juices, soups, soy milk, etc. These “paperboard containers” have some degree of protective coatings on their inner and outer surfaces. However, the edges typically do not receive coatings in order to minimize manufacturing costs. As a result, the exposed edges are susceptible to fluid absorption during the pasteurization or sterilization processes. A “soggy” container may be deemed defective if too much absorption occurs along an exposed edge.

Additional overpressure for pasteurizing or sterilizing paperboard containers of foodstuffs may be achieved in a spray retort, where water or another suitable processing fluid is sprayed from the top (and optionally also from the sides) of the vessel through the load of containers. The water may be heated through external means, or alternatively steam may be directly injected into the vessel.

FIG. 1 illustrates a prior art spray water retort system 10. A cylindrical pressure vessel 14 houses a load 18 containing paperboard containers 22. The containers 22, being substantially rectilinear in shape, are arranged to lie on their long sides with the ends of each container 22 facing the side of the vessel 14. A plurality of top spray nozzles 26A-26E is located at the top interior of the vessel 14 and is angled to spray water onto the top of the load 18. First and second side spray nozzles 32A and 32B are located on the interior opposing side portions 30A and 30B of the vessel 14 and are angled to spray water onto the side of the load (i.e., the bottoms or ends of the containers 22).

The prior art spray water retort system 10 described above has been found to cause excessive fluid absorption along the edges defined at the ends of the paperboard containers facing the interior side of the vessel 14. Thus, a need exists for an improved retort system that reduces the amount of absorption along the exposed edges of the containers, which thereby reduces the number of defective “soggy” containers.

### SUMMARY

A spray retort system includes a vessel having an interior and a load defined by at least one paperboard container. The at least one paperboard container comprises a body having a top end, a bottom end, and an exposed edge, and the load is positionable within the interior of the vessel. The system further includes at least one nozzle positioned within a top interior portion of the vessel to spray processing fluid onto a top of the load and a first supplemental nozzle arranged on the top interior portion of the vessel to spray processing fluid downwardly along the exposed edge of the at least one paperboard container.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of the present disclosure will become more readily appreciated by reference to the following detailed description, when taken in conjunction with the accompanying drawings, wherein:

FIG. 1 is a side cross-sectional side view of a prior art spray retort system;

FIG. 2 is a side cross-sectional side view of a spray retort system formed in accordance with a first exemplary embodiment of the present disclosure;

FIG. 3 is a side cross-sectional side view of a spray retort system formed in accordance with a second exemplary embodiment of the present disclosure;

FIG. 4 is an isometric top view of an exemplary paperboard container for use with the spray retort system of FIGS. 2 and 3; and

FIG. 5 is an isometric bottom view of the paperboard container of FIG. 4.

### DETAILED DESCRIPTION

The inventors herein have determined that the impact of the water droplets from the nozzles on a container is an important parameter in causing edgewise moisture penetration. The greater the droplet impact on the container, the greater the moisture penetration into the exposed paperboard edges. The droplet impact administered to a load in prior art nozzle arrangements has resulted in excessive moisture penetration into exposed paperboard edges.

The first and second exemplary spray retort systems 40 and 140 of the present disclosure includes a number of retort features that seek to decrease the impact of the processing fluid droplets by altering the nozzle locations and impact pattern. The retort features may be optimized for ensuring a satisfactory temperature and pressure distribution of the spray fluid flowing through a load in the retort. For instance, the distance between the nozzles and the load, the location of the nozzle, and the number of nozzles in the retort system may be adjusted. These features may be used singularly or jointly depending on the characteristics of the container and depending on the pressure and temperature profiles required for the particular foodstuff. Moreover, these features may be used in combination with the features described and illustrated in U.S. Pat. No. 7,104,465, entitled “Water Spray Retort System Suitable for Paperboard Packages,” issued on Sep. 12, 2006, the disclosure of which is incorporated by reference herein in its entirety, to achieve substantially the same total droplet impact.

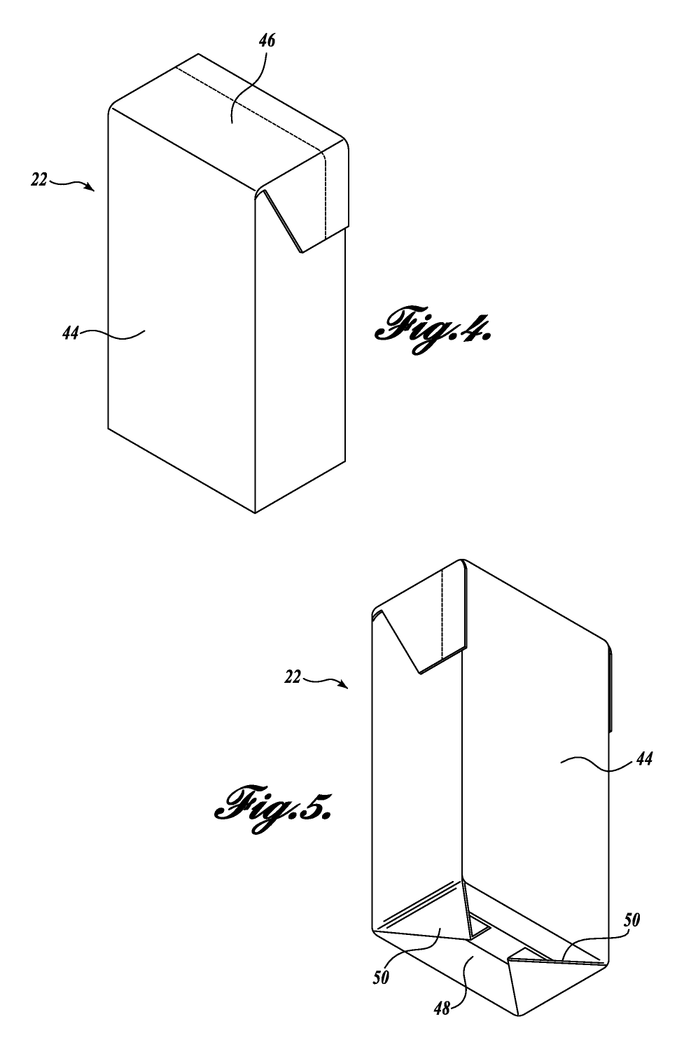

As used herein, the term “paperboard container” is meant to describe a container or package generally composed of a coated piece of paperboard folded into a predefined shape, such as a rectilinear or square shape, a pouch shape, etc., which includes at least one exposed edge having no coating or minimal coating. In the exemplary embodiments, and referring to FIGS. 4 and 5, the paperboard container 22 is a coated piece of paperboard folded into a rectilinear shape to define an elongated body 44, a top end 46, and a bottom end 48. The bottom end 48, which can best be seen in FIG. 5, includes at least one exposed, uncoated edge 50. It should be appreciated that any suitable paperboard container having at least one exposed edge may instead be used.

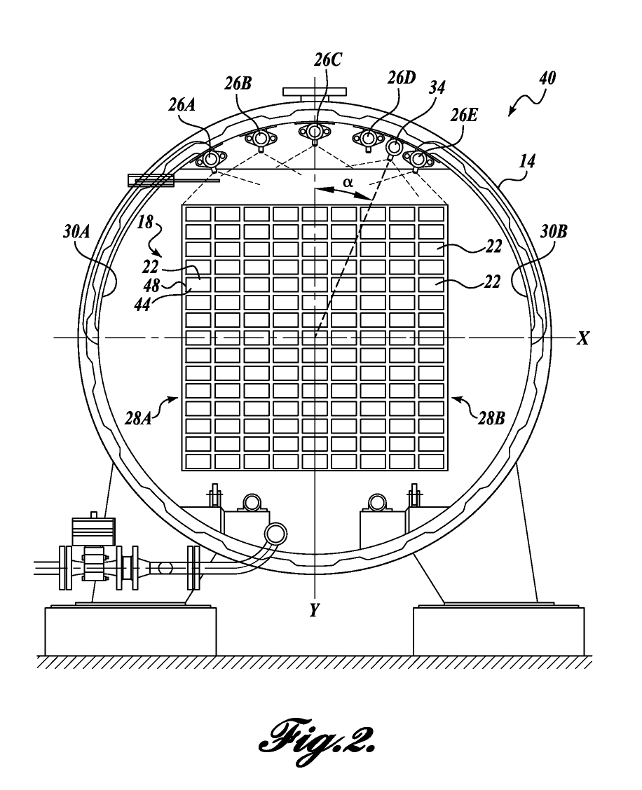

Referring to FIG. 2, the first exemplary spray retort system 40 will now be described in detail. Aspects of the spray retort system 40 are identical to the prior art spray retort system 10 described above; and therefore, the same references numerals of identical parts are used for convenience. Moreover, aspects of the spray retort system 40, as generally described in U.S. Pat. No. 7,104,465, entitled “Water Spray Retort System Suitable for Paperboard Packages,” issued on Sep. 12, 2006, the disclosure of which is incorporated by reference herein in its entirety, and as generally known in the art, will not be described herein for brevity.

The spray retort system 40 includes a cylindrical pressure vessel 14 sized and configured to house a load 18. The load 18 is defined by a pallet, frame, etc., which supports at least one paperboard container 22 arranged in a column, and preferably at least first and second paperboard containers 22 arranged in first and second columns. In the depicted embodiment, the load 18 is defined by a plurality of paperboard containers 22 arranged in a plurality of columns 28A (to the left of the y-axis) and 28B (to the right of the y-axis). However, it should be appreciated that the load 18 may be defined by any suitable number of columns, rows, etc. suitable for the vessel size. Each container 22 is arranged on its elongated body 44 with its bottom end 48 facing an interior side portion 30A or 30B of the vessel 14 (only one container 22 labeled for ease of illustration).

In the depicted embodiment, the load 18 is substantially centered within the interior of the vessel 14, with the center of the vessel 14 defined by x- and y-axes. However, it can be appreciated that the load 18 may instead be off-center or in another location within the vessel 14, with the nozzle placement adjusted accordingly. The load 18 is also of a predefined width and height suitable for the intended vessel 14, and it may extend along a portion or substantially the entire length of the vessel 14 (in the z-direction, into the page).

A plurality of top spray nozzles 26A-26E are arranged on the top interior portion of the vessel 14 at a predefined distance from the center of the load 18 (i.e., relative to the x- and y-axes) and offset at a predefined angle from the vertical y-axis. The locations of the top spray nozzles 26A-26E are optimized to spray water or another suitable processing fluid onto the top of the load 18 (onto the elongated bodies 44 of the containers 22) and to minimize the droplet impact on the containers 22. The placement of the top spray nozzles 26A-26E may be adjusted in a position to accommodate a narrower or wider load 18 as well as a taller or shorter load 18.

For example, in the depicted embodiment the top spray nozzles 26A-26E are arranged on the top interior portion of the vessel 14 such that the nozzles are offset from the vertical y-axis substantially as follows:
Nozzle 26A: −30 degrees (−30°)
Nozzle 26B: −15 degrees (−15°)
Nozzle 26C: 0 degrees (0°)
Nozzle 26D: 15 degrees (15°)
Nozzle 26E: 30 degrees (30°)

Moreover, the top of the load 18 extends to about ¾ of the height of the vessel 14 and is distanced from the top spray nozzles 26A-26E accordingly. However, as noted above, the top spray nozzles 26A-26E may instead be moved closer to the load 18 (along the x- and/or y-axes) and positioned at a smaller or larger angle offset from the vertical y-axes to accommodate a smaller or larger load.

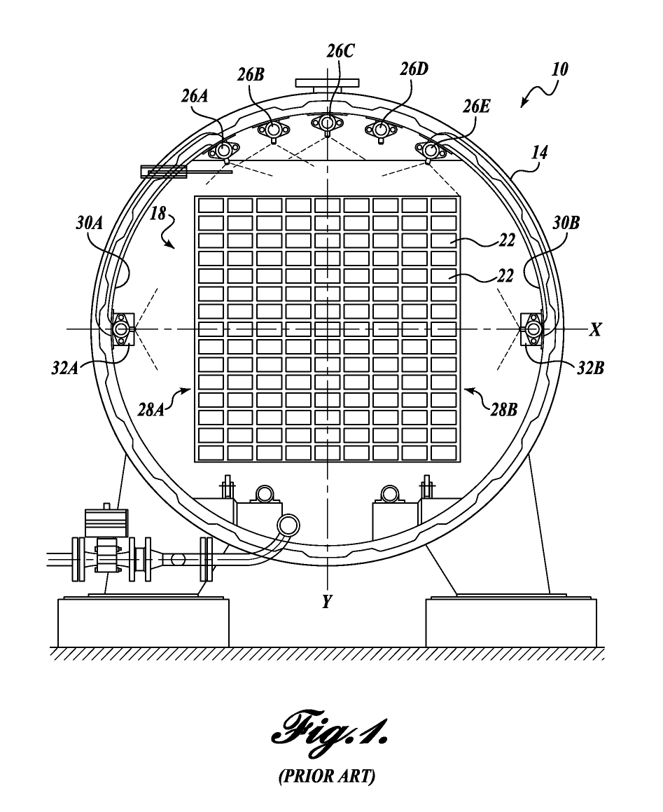

As noted above with respect to FIG. 1, the prior art spray retort system 10 has been found to cause excessive fluid absorption along the exposed edges 50 defined on the bottom 48 of the paperboard containers 22, which face the interior side of the vessel 14 during sterilization/pasteurization. In the improved spray retort system 40 of FIG. 2, the first and second side spray nozzles 32A and 32B have been removed. The inventors found that removal of the first and second side spray nozzles 32A and 32B significantly decreased the droplet impact on the bottoms 48 of the containers 22. However, removal of the first and second side spray nozzles 32A and 32B also adversely affected the temperature distribution of the spray fluid flowing through the load 18.

The inventors found that the addition of a first supplemental nozzle 34 added to the top interior of the vessel 14 (in the depicted embodiment, between nozzles 26D and 26E) helps maintain good temperature distribution through columns 28B of the load 18 (to the right of the y-axis) while minimizing the droplet impact on the bottoms 48 of the containers 22 in columns 28B. The first supplemental nozzle 34 is positioned at an angle α offset from the vertical y-axis, with the angle α optimized such that it sprays water or another suitable processing fluid downwardly onto the side of the load 18 along the bottoms 48 of the containers 22 in columns 28B.

For example, in the depicted embodiment, the first supplemental nozzle 34 is positioned at an angle α within a range of about 15 to 30 degrees (15° to 30°) from the vertical y-axis. More specifically, the first supplemental nozzle 34 is positioned at about 23 degrees (23°) from the vertical y-axis such that it sprays water or another suitable processing fluid downwardly onto the side of the load 18 along the bottoms 48 of the containers 22 in columns 28B. With a nozzle positioned at about 15 to 30 degrees (15 to) 30°), or at about 23 degrees (23°) from the vertical y-axis, the nozzle 34 does not spray water or another suitable processing fluid directly onto the bottoms 48 of the containers 22 in columns 28B, thereby reducing the amount of absorption along the exposed edges 50 of the containers 22 in column 28B and resulting in less defective “soggy” containers. It should be appreciated that the distance of the first supplemental nozzle 34 from the center of the load 18 may also be adjusted to accommodate the size of the load 18.

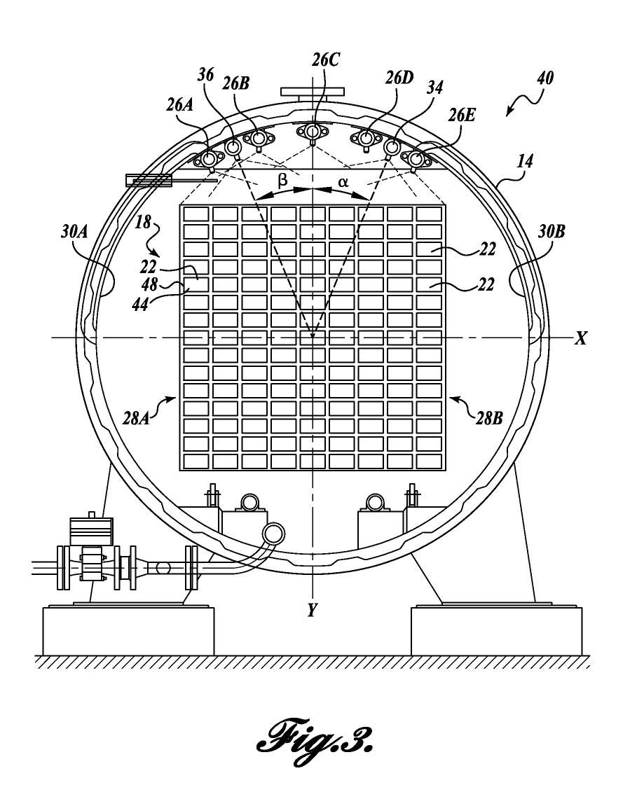

Referring to FIG. 3, the second exemplary spray retort system 140 will now be described in detail. The second exemplary spray retort system 140 is identical to the first exemplary spray retort system 40 described above except that a second supplemental nozzle 36 has been added to the top interior of the vessel 14.

The addition of a second supplemental nozzle 36 added to the top interior of the vessel 14 (in the depicted embodiment, between nozzles 26A and 26B) helps maintain good temperature distribution through columns 28A (to the left of the y-axis) of the load 18 while minimizing the droplet impact on the bottoms 48 of the containers 22 in column 28A. The second supplemental nozzle 36 is positioned at an angle β offset from the vertical y-axis, with the angle β optimized such that it sprays water or another suitable processing fluid downwardly onto the side of the load 18 along the bottoms 48 of the containers 22 in columns 28A.

For example, in the depicted embodiment, the second supplemental nozzle 36 is positioned at an angle β within a range of about −15 to −30 degrees (−15° to −30°) from the vertical y-axis. More specifically, the second supplemental nozzle 36 is positioned at about −23 degrees (−23°) from the vertical y-axis, which is substantially equivalent to angle α to ensure symmetry of temperature distribution through the load 18.

With a nozzle positioned at about −15 to −30 degrees (−15° to −30°), or at about −23 degrees (−23°), the nozzle 36 does not spray water or another suitable processing fluid directly onto the bottoms 48 of the containers 22 in columns 28A, thereby reducing the amount of absorption along the exposed edges 50 of the containers 22 in columns 28A and resulting in less defective “soggy” containers. It should be appreciated that the distance of the second supplemental nozzle 36 from the center of the load 18 may also be adjusted to accommodate the size of the load 18.

The locations of the first and second supplemental nozzles 34 and 36 (as well as any other relevant features of the spray retort system 40 or 140, respectively) may be adjusted to accommodate loads having different container configurations, sizes, etc. As a non-limiting example, the containers 22 may instead be arranged such that the top ends 46 face an interior side portion 30A or 30B of the vessel 14 and the bottom ends 48 face each other. In such a configuration, the first and second supplemental nozzles 34 and 36 may be positioned on either side of nozzle 26C and angled toward the vertical y-axis to spray water or another suitable processing fluid downwardly onto the bottom ends 48 of the containers 22. Thus, it should be appreciated that the first and second exemplary spray retort systems 40 and 140 are illustrative only, and should not be seen as limiting the scope of the claimed subject matter. Accordingly, while various embodiments have been illustrated and described, it will be appreciated that various changes can be made therein without departing from the spirit and scope of the present disclosure.

The embodiments of the invention in which an exclusive property or privilege is claimed are defined as follows:

1. A spray retort system, comprising:
(a) a vessel having an interior;
(b) a load defined by at least one paperboard container, wherein the at least one paperboard container comprises a body having a top end, a bottom end, and an exposed edge, wherein the load is positionable within the interior of the vessel;
(c) at least one nozzle positioned within a top interior portion of the vessel to spray processing fluid onto a top of the load; and
(d) a first supplemental nozzle arranged on the top interior portion of the vessel to spray processing fluid downwardly along the exposed edge of the at least one paperboard container.

2. The system of claim 1, wherein the at least one paperboard container is arranged on the load with the exposed edge facing a first side interior portion of the vessel.

3. The system of claim 2, wherein the exposed edge is defined on one of the top and bottom ends of the paperboard container.

4. The system of claim 1, wherein the load comprises a plurality of paperboard containers arranged in a first column, each exposed edge of the paperboard containers in the first column facing a first side interior portion of the vessel.

5. The system of claim 4, wherein the load is substantially centered within the vessel along an x- and y-axis.

6. The system of claim 5, wherein the first supplemental nozzle is arranged on the top interior portion of the vessel in a position that is offset from the y-axis by an angle within the range of about 15 to 30 degrees (15° to 30°).

7. The system of claim 5, wherein the first supplemental nozzle is arranged on the top interior portion of the vessel in a position that is offset from the y-axis by an angle of about 23 degrees (23°).

8. The system of claim 5, wherein the load further comprises a plurality of paperboard containers arranged in a second column, each exposed edge of the paperboard containers in the second column facing a second side interior portion of the vessel.

9. The system of claim 8, wherein the second supplemental nozzle is arranged on the top interior portion of the vessel in a position that is offset from the y-axis by an angle within the range of about −15 to −30 degrees (−15° to −30°).

10. The system of claim 9, wherein the second supplemental nozzle is arranged on the top interior portion of the vessel in a position that is offset from the y-axis by an angle of about −23 degrees (−23°).

11. The system of claim 1, wherein no side spray nozzles are included.

12. A spray retort system, comprising:
(a) a vessel having an interior;
(b) a load defined by first and second paperboard containers, wherein each of the first and second paperboard containers comprises a body having a top end, a bottom end, and an exposed edge, wherein the load is positionable within the interior of the vessel;
(c) at least one nozzle positioned within a top interior portion of the vessel to spray processing fluid onto a top of the load;
(d) a first supplemental nozzle arranged on the top interior portion of the vessel to spray processing fluid downwardly along the exposed edge of the first paperboard container; and
(e) a second supplemental nozzle arranged on the top interior portion of the vessel to spray processing fluid downwardly along the exposed edge of the second paperboard container.

13. The system of claim 12, wherein the first paperboard container is arranged on the load with the exposed edge facing a first side interior portion of the vessel, and wherein the second paperboard container is arranged on the load with the exposed edge facing a second side interior portion of the vessel.

14. The system of claim 13, wherein the exposed edge is defined on one of the top and bottom ends of the paperboard container.

15. The system of claim 12, wherein the first and second paperboard containers are arranged in first and second columns, the exposed edge of the first paperboard container facing a first side interior portion of the vessel, and the exposed edge of the second paperboard container facing a second side interior portion of the vessel.

16. The system of claim 15, wherein the load is substantially centered within the vessel along an x- and y-axis.

17. The system of claim 16, wherein the first supplemental nozzle is arranged on the top interior portion of the vessel in a position that is offset from the y-axis by an angle within the range of about 15 to 30 degrees (15° to 30°).

18. The system of claim 17, wherein the first supplemental nozzle is arranged on the top interior portion of the vessel in a position that is offset from the y-axis by an angle of about 23 degrees (23°).

19. The system of claim 16, wherein the second supplemental nozzle is arranged on the top interior portion of the vessel in a position that is offset from the y-axis by an angle within the range of about −15 to −30 degrees (−15° to −30°).

20. The system of claim 19, wherein the second supplemental nozzle is arranged on the top interior portion of the vessel in a position that is offset from the y-axis by an angle of about −23 degrees (−23°).

21. The system of claim 12, wherein no side spray nozzles are included.
